(19) United States
(12) Patent Application Publication
(10) Pub. No.: US 2014/0193266 A1
(43) Pub. Date: Jul. 10, 2014

(54) COUPLING APPARATUSES AND METHODS OF FORMING THE SAME

(71) Applicant: HONEYWELL INTERNATIONAL INC., Morristown, NJ (US)

(72) Inventors: Krish Krishnamurthy, Chandler, AZ (US); Robert Keiser, Cave Creek, AZ (US)

(73) Assignee: HONEYWELL INTERNATIONAL INC., Morristown, NJ (US)

(21) Appl. No.: 13/737,648

(22) Filed: Jan. 9, 2013

(51) Int. Cl. F16D 1/02; B05D 7/14

(52) U.S. Cl. CPC F16D 1/02; B05D 7/14
USPC 416/204 A; 427/248.1; 427/523; 403/179

(57) ABSTRACT

Coupling apparatuses and methods of forming coupling apparatuses are provided herein. In an embodiment, a coupling apparatus includes a first component that includes a first metal substrate and a second component that includes a second metal substrate. The first metal substrate includes a titanium-based material. The second component is adapted to contact the first component in shear engagement. A protective coating is disposed on at least one of the first metal substrate or the second metal substrate. The protective coating consists of a first contact layer and, optionally, a diffusion barrier layer disposed between the first contact layer and the corresponding metal substrate. The first contact layer has a thickness of less than or equal to about 5 microns and includes material that is inert to titanium. The first contact layer has a contact surface that is adapted to directly contact an opposing surface in shear engagement.

### TECHNICAL FIELD

The technical field generally relates to coupling apparatuses, and more particularly relates to metal-to-metal coupling apparatuses including components that are adapted to contact each other in shear engagement.

### BACKGROUND

Metal-to-metal coupling of components in shear engagement, such as through curvic coupling configurations, is known in the art. Such metal-to-metal coupling through shear engagement enables transfer of force, such as rotational or linear force, between different components while avoiding the need to form a unitary apparatus that includes the components. Curvic coupling configurations, in particular, offer precise locating features to ensure exact alignment of the components and facilitate simple assembly. One specific application that benefits from precise locating features that are offered by curvic coupling configurations is coupling of components in a turbine engine shaft, such as an aircraft engine. However, various other metal-to-metal coupling configurations are known in the art that enable contact to be maintained between different components through shear engagement, and various applications can benefit from metal-to-metal coupling configurations.

In various applications, metal-to-metal couplings of components in shear engagement are subject to high stress and temperature conditions. Because many metal-to-metal coupling applications require extreme accuracy and have narrow tolerance ranges, geometric uniformity of the metal-to-metal couplings is a primary concern both during initial manufacture and during an operating life of the components that are coupled in shear engagement.

Titanium and titanium alloys are widely used in high stress applications, especially under conditions where a combination of high strength, low density, and corrosion resistance is desired. However, despite high strength properties of titanium, titanium components used in metal-to-metal coupling applications often exhibit excessive wear and material transfer, even after short operation times. Such excessive wear and material transfer results in dimensional changes and loss of surface integrity, which is particularly problematic in applications that require extreme accuracy.

Accordingly, it is desirable to provide coupling apparatuses, such as turbine shafts, and methods of forming coupling apparatuses in which metal components are coupled through shear engagement with at least one of the metal components including titanium, with measures taken to hinder wear and material transfer while maintaining narrow dimensional tolerances that are associated with applications that require extreme accuracy.

### BRIEF SUMMARY

Coupling apparatuses and methods of forming coupling apparatuses are provided herein. In an embodiment, a coupling apparatus includes a first component that includes a first metal substrate and a second component that includes a second metal substrate. The first metal substrate includes a titanium-based material. The second component is adapted to contact the first component in shear engagement. A protective coating is disposed on at least one of the first metal substrate or the second metal substrate. The protective coating consists of a first contact layer and, optionally, a diffusion barrier layer disposed between the first contact layer and the corresponding metal substrate. The first contact layer has a thickness of less than or equal to about 5 microns and includes material that is inert to titanium. The first contact layer has a contact surface that is adapted to directly contact an opposing surface in shear engagement.

In another embodiment, a method of forming a coupling apparatus is provided. The coupling apparatus includes a first component and a second component that is adapted to contact the first component in shear engagement. The method includes providing a first metal substrate of the first component, with the first metal substrate including a titanium-based material. A second metal substrate of the second component is also provided. A protective coating is formed on at least one of the first metal substrate or the second metal substrate. The protective coating consists of a first contact layer and, optionally, a diffusion barrier layer that is disposed between the first contact layer and the corresponding metal substrate. The first contact layer has a thickness of less than or equal to about 5 microns and includes material that is inert to titanium. The first contact layer has a contact surface that is adapted to directly contact an opposing surface in shear engagement.

In another embodiment, the coupling apparatus is a turbine engine shaft that includes a compressor rotor and a turbine rotor. The compressor rotor includes a first metal substrate that includes a titanium-based material. The turbine rotor includes a second metal substrate that is adapted to contact the compressor rotor in shear engagement. The second metal substrate includes metal chosen from nickel, iron, titanium, alloys thereof, or mixtures thereof. A protective coating is disposed directly on at least one of the first metal substrate or the second metal substrate. The protective coating consists of a physical vapor-deposited contact layer and, optionally, a diffusion barrier layer disposed between the physical vapor-deposited contact layer and the corresponding metal substrate. The physical vapor-deposited contact layer has a thickness of less than or equal to about 5 microns and includes material that is inert to titanium. In particular, the physical vapor-deposited contact layer includes material chosen from gold, platinum, cobalt, or alloys thereof; cobalt oxide, boron oxide, or boron nitride; or mixtures thereof. The physical vapor-deposited contact layer has a contact surface that is adapted to directly contact an opposing surface in shear engagement. The compressor rotor and the turbine rotor are adapted to contact in shear engagement through a curvic coupling configuration, with the contact surface of the physical vapor-deposited contact layer in shear engagement with the opposing surface in the curvic coupling configuration.

### BRIEF DESCRIPTION OF THE DRAWINGS

The various embodiments will hereinafter be described in conjunction with the following drawing figures, wherein like numerals denote like elements, and

FIG. 1 is a partial schematic cross-sectional side view of a coupling apparatus including a first component and a second component that are adapted to contact in shear engagement in accordance with an embodiment;

FIG. 2 is a partial schematic cross-sectional side view of a coupling apparatus including a first component and a second component that are adapted to contact in shear engagement in accordance with another embodiment;

FIG. 3 is a partial schematic side view of a coupling apparatus including a first component and a second component that are adapted to contact in shear engagement through a curvic coupling configuration in accordance with another embodiment; and

FIG. 4 is a partial perspective side view of two components of a turbine engine shaft that are adapted to contact each other in shear engagement through a curvic coupling in accordance with another embodiment.

### DETAILED DESCRIPTION

The following detailed description is merely exemplary in nature and is not intended to limit the various embodiments or the application and uses thereof. Furthermore, there is no intention to be bound by any theory presented in the preceding background or the following detailed description.

Coupling apparatuses and methods of forming the coupling apparatuses are provided herein that enable metal-to-metal coupling of components in shear engagement, where at least one of the components includes a titanium-based material, with a protective coating provided to hinder wear and material transfer that would otherwise be associated with the presence of titanium in the coupling apparatuses. In particular, the protective coating includes a first contact layer that is inert to titanium and that has a thickness of less than or equal to about 5 microns, which enables narrow dimensional tolerances to be maintained in the metal-to-metal coupling even within applications that require extreme accuracy. Without being bound to any particular theory, it is believed that metal-to-metal couplings, wherein one or more of the components in the coupling includes the titanium-based material, experience particularly high wear and material transfer rates due to adhesion that occurs between the components at extreme operating conditions (generally known in the art as adhesive wear). The protective coatings may be formed, for example, through physical vapor deposition and do not materially alter dimensional tolerances in the metal-to-metal coupling while maximizing a useful life of the coupling apparatuses by forming a lubricious buffer between surfaces that contain the titanium-based material and opposing surfaces that would otherwise be in shear engagement.

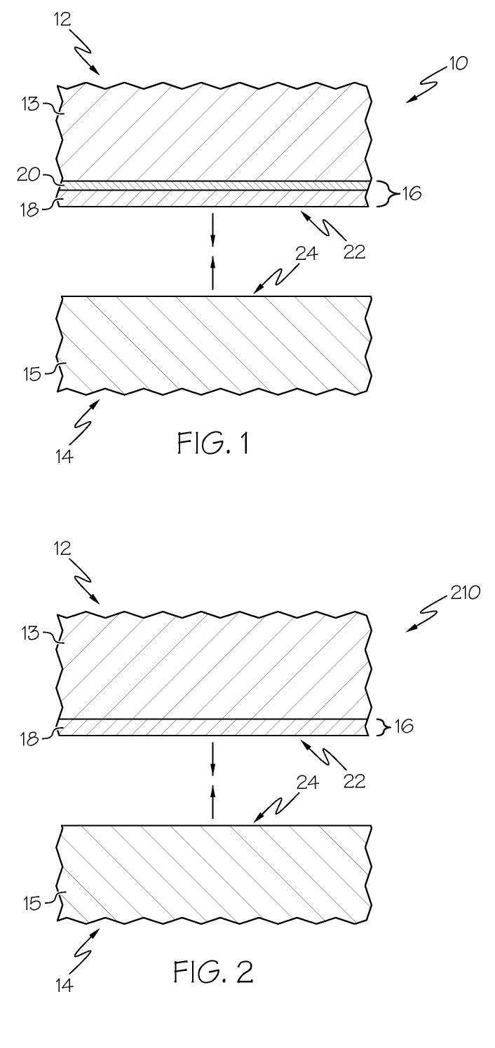

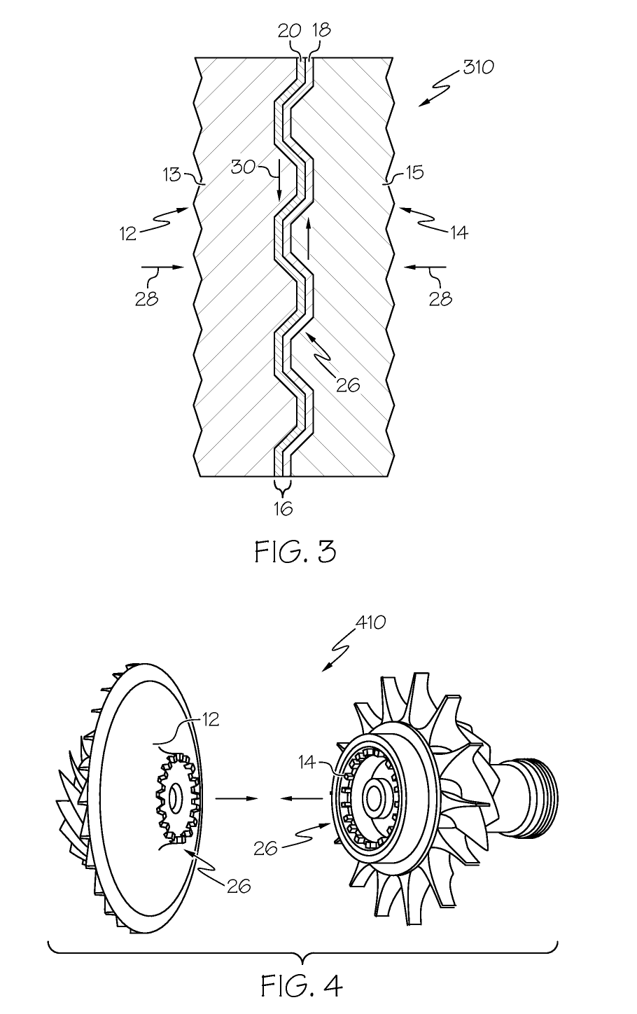

As referred to herein, metal-to-metal coupling refers to a connection between metal substrates that possess material properties that are generally characteristic of metals, such as high electrical and thermal conductivity and good malleability. The metal substrates also exhibit metallic bonding, readily shed electrons to form positive ions, and are generally free from ionic or covalent bonds, as opposed to ceramic materials, dielectric materials, and the like, which possess ionic or covalent bonds. As referred to herein, “shear engagement” refers to physical coupling between two or more separate components in a manner that allows for the separate components to be disengaged from each other, but with the components coupled in such a manner to enable transfer of force, such as rotational or linear force, therebetween under influence of normal and frictional forces between the coupled components. It is to be appreciated that shear engagement between the components may be accomplished through various configurations of the components. For example, in various embodiments and as shown generally in FIGS. 1 and 2, the components may be configured with substantially parallel contact surfaces that are maintained in shear engagement primarily through application of normal force. Alternatively, in other embodiments and as shown generally in FIG. 3, the components may be configured with complementary contact surface contours to enable shear engagement with minimal normal forces applied between the components. The various embodiments are described in further detail below.

An embodiment of an exemplary coupling apparatus 10 will now be described with reference to FIG. 1. The coupling apparatus 10 includes a first component 12 that includes a first metal substrate 13 and a second component 14 that includes a second metal substrate 15, with the second component 14 adapted to contact the first component 12 in shear engagement. The first component 12 and the second component 14 are not limited and can be any components that include a metal substrate and that are adapted to contact in shear engagement. In an embodiment, the metal substrates are articles that are formed through a conventional bulk metal-forming process such as, but not limited to, casting, forging, stamping, powder metallurgy, extrusion, or the like and then machined to final configuration. In an embodiment, “metal substrates” refer to bulk metal structures and exclude any other layers that may be subsequently formed on the bulk metal structures.

The first metal substrate 13 includes the titanium-based material, which provides an excellent combination of high strength, low density, and corrosion resistance and, thus, is an excellent material for many applications where coupling apparatuses as described herein are used. As referred to herein, “titanium-based material” refers to material that includes titanium either as the lone metal, or includes titanium within a titanium alloy along with other alloying elements but with titanium present in amounts that are greater than alloying amounts, such as at least 50 weight %, or such as from 80 to 99 weight %, based on the total weight of the titanium-based material. Examples of titanium alloys include, but are not limited to, Ti-6Al-4V, Ti-6Al-2Sn-4Zr-2Mo and Ti-6Al-2Sn-4Zr-6Mo. In an embodiment, the first metal substrate 13 only includes the titanium or titanium alloy.

The second component 14 includes the second metal substrate 15, and the second component 14 is adapted to contact the first component 12 in shear engagement. In particular, when in contact, the second component 14 and the first component 12 are only in contact in shear engagement and, in the absence of normal and/or frictional forces applied to the components to maintain contact, the first component 12 and the second component 14 are separable. The second metal substrate 15 may include any metal, and the second metal substrate 15 has features that are characteristic of metal as described above. Metals that may be included in the second metal substrate 15 are not limited. Examples of suitable metals that may be included in the second metal substrate 15 include, but are not limited to, those chosen from nickel, iron, titanium, alloys thereof, or mixtures thereof. Specific examples of suitable metals that may be included in the second metal substrate 15 include the titanium alloys as set forth above; nickel alloys such as IN-718 and Mar-M-247; and iron alloys such as 17-4PH and AM-350. In one embodiment, the second metal substrate 15 includes titanium or a titanium alloy. In one specific embodiment, the second metal substrate 15 has substantially the same chemical composition as the first metal substrate 13. By “substantially the same”, it is meant that the first metal substrate 13 and the second metal substrate 15 may be formed from the same nominal compositions. In an embodiment, the second metal substrate 15 only includes the metals or metal alloys as set forth above.

A protective coating 16 is disposed on at least one of the first metal substrate 13 or the second metal substrate 15, and the protective coating 16 hinders wear and material transfer that would otherwise be associated with the presence of the titanium-based material in the first metal substrate 13 and, in various embodiments, the second metal substrate 15. In all embodiments, the protective coating 16 is disposed between and prevents direct contact between the first metal substrate 13 and the second metal substrate 15 under circumstances in which the first component 12 and the second component 14 are in contact in shear engagement, thereby hindering wearing of and material transfer from the first metal substrate 13. In an embodiment and as shown in FIG. 1, the protective coating 16 is disposed on the first metal substrate 13 and the second metal substrate 15 is free from the protective coating 16 thereon. In other embodiments, although not shown, both the first metal substrate and the second metal substrate include the protective coating. In yet other embodiments, although also not shown, the second metal substrate includes the protective coating and the first metal substrate is free from the protective coating thereon. In an embodiment and as shown in FIG. 1, the protective coating 16 is disposed directly on at least one of the first metal substrate 13 or the second metal substrate 15, i.e., no intervening layers of any other material may be present between the protective coating 16 and the underlying metal substrate.

The protective coating 16, as described herein, includes a first contact layer 18 that provides the primary protective function, and the protective coating 16 may optionally include a diffusion barrier layer 20. The first contact layer 18 has a contact surface that is adapted to directly contact an opposing surface 24 in shear engagement. For example, in an embodiment and as shown in FIG. 1, the first contact layer 18 is adapted to directly contact a second contact surface of the second metal substrate 15 as the opposing surface 24. Alternatively, in other embodiments and although not shown, the opposing surface may be a second contact surface of another protecting coating on the second metal substrate. Alternatively still, in other embodiments and although not shown, the protective coating is disposed on the second metal substrate and the opposing surface may be a second contact surface of the first metal substrate.

The protective coating 16 only includes the first contact layer 18 and the optional diffusion barrier layer 20, and the first contact layer 18 has a thickness of less than or equal to about 5 microns to enable underlying surface contours of the particular metal substrate upon which the protective coating 16 is disposed to be maintained on a contact surface of the first contact layer 18 and to sufficiently hinder wear of and material transfer from the first metal substrate 13. In particular, the first contact layer 18 may have a thickness of from about 500 Angstroms to about 5 microns, such as from about 1 micron to about 3 microns. The first contact layer 18 also includes material that is inert to titanium, meaning that the material of the first contact layer 18 will resist chemical reaction with titanium throughout a range of operating conditions specified for the particular coupling apparatus. In this regard, the first contact layer 18 may have a chemical makeup that resists breakdown or reaction with titanium throughout the range of operating conditions of the coupling apparatuses. In an embodiment, the first contact layer 18 includes material chosen from gold, platinum, cobalt, or alloys thereof; cobalt oxide, boron oxide, or boron nitride; or mixtures thereof. The protective layer that includes cobalt oxide may be formed by applying metallic cobalt or a cobalt base alloy, following by oxidizing the metallic cobalt or cobalt base alloy such as by exposing the metallic cobalt or cobalt base alloy to an oxidizing environment in furnace to form the protective coating 16. In an embodiment, the aforementioned materials are present in the first contact layer 18 in an amount of at least about 90 weight %, such as from 99 to about 100 weight %, based on the total weight of the first contact layer 18. In one specific embodiment, the first contact layer 18 includes gold, which is both inert to titanium and which provides excellent protection to the first metal substrate 13.

As alluded to above, the protective coating 16 may optionally include the diffusion barrier layer 20. When present and as shown in FIG. 1, the diffusion barrier layer 20 is disposed between the first contact layer 18 and the corresponding metal substrate. The diffusion barrier layer 20 is present to hinder diffusion of chemical species between the first contact layer 18 and the underlying metal substrate. In this regard, presence of the diffusion barrier layer 20 may be most beneficial when the protective coating 16 is disposed on metal substrates that include the titanium-based material to hinder contamination of the metal substrate during extreme operating conditions. An example of a suitable material for the diffusion barrier layer 20 is tungsten. In an embodiment, the diffusion barrier layer 20 has a thickness of less than about 1 micron, such as less than or equal to about 500 Angstroms.

In another embodiment of a coupling apparatus 210 and as shown in FIG. 2, the first contact layer 18 is disposed directly on the underlying metal substrate, in the absence of intervening layers. In particular, as set forth above, the diffusion barrier layer 20 is optional and the first contact layer 18 may be in direct contact with the underlying metal substrate, thereby minimizing impact on feature tolerances in the first contact surface 22 of the protective coating 16.

To enable the protective coating 16 to be uniformly formed with the first contact layer 18 and the diffusion barrier layer 20, when present, to be formed at the relatively small thicknesses as described above, the first contact layer 18 may be further defined as a physical vapor-deposited contact layer. For example, in a specific embodiment, the first contact layer 18 is an ion-plated contact layer. The diffusion barrier layer 20 may be a physical vapor-deposited diffusion barrier layer 20. The manner by which the first contact layer 18 and the diffusion barrier layer 20 are formed may provide distinct physical characteristics, such as uniformity at the relatively small thicknesses, that cannot be obtained through other formation techniques. Further details regarding the manner in which the protective coating 16 is formed are provided below.

In another embodiment of a coupling apparatus 310 and as shown in FIG. 3, the first component 12 and the second component 14 are adapted to contact in shear engagement through a curvic coupling configuration 26. In this embodiment, the contact surface of the first contact layer 18 is in shear engagement with the opposing surface 24 in the curvic coupling configuration 26. More specifically, as shown in FIG. 3, the contact surface of the first contact layer 18 is in shear engagement with the second contact surface of the second metal substrate 15, with normal forces (represented by force lines 28) urging the first component 12 and the second component 14 together. The curvic coupling configuration 26 includes a series of teeth that are defined in the first component 12 and the second component 14 in a mating pattern. The contact surface of the first contact layer 18 is in shear engagement with the opposing surface 24 in the curvic coupling configuration 26, which enables relative movement between the first component 12 and the second component 14 to be hindered when subject to rotational forces 30. In the absence of the protective coating 16, wear and material transfer from the first metal substrate 13 is particularly prevalent with the curvic coupling configuration 26 due to extreme heat and stress that may be generated between the teeth in the curvic coupling configuration 26 during operation of the coupling apparatus 310.

A method of forming a coupling apparatus 10 that includes the first component 12 and the second component 14, as described above in the context of FIGS. 1-3, will now be described. In the exemplary method, the first metal substrate that includes the titanium-based material may be provided, either by procuring the first metal substrate from a supplier or by forming the first metal substrate. Similarly, the second metal substrate is provided, either by procuring the first metal substrate from a supplier or by forming the first metal substrate. In this regard, the curvic coupling configuration may be formed in the first metal substrate and the second metal substrate through conventional techniques, such as through precision machining of the first metal substrate and the second metal substrate. The protective coating is then formed on at least one of the first metal substrate or the second metal substrate, and may be formed directly upon the first metal substrate and/or the second metal substrate in the absence of intervening layers. The protective coating is formed to include the first contact layer that has a thickness of less than or equal to about 5 microns, and a diffusion barrier layer may optionally be formed on the underlying metal substrate prior to forming the first contact layer. The first contact layer and the diffusion barrier layer are described in detail above. To form the first contact layer and the optional diffusion barrier layer with such small thicknesses, the first contact layer and/or the diffusion barrier layer may be formed through physical vapor-deposition (PVD). As known in the art, physical vapor deposition generally involves condensation of a vaporized form of a film material (in this case, the material of the first contact layer or the material of the diffusion barrier layer, respectively) onto a target surface (in this case, either the underlying metal substrate or the diffusion barrier layer, when present). In an embodiment, PVD is conducted with plasma assistance, which enables relatively uniform deposition and provides excellent surface adhesion. One specific example of a suitable PVD technique is ion plating. Another specific example of a PVD technique is sputtering. Particular conditions for conducting PVD techniques are generally known in the art.

Referring now to FIG. 4, a specific embodiment of a coupling apparatus 410 is shown. In particular, in this embodiment, the coupling apparatus 410 is a turbine engine shaft 410 that includes a compressor rotor 12 as an example of the first component 12 described above. The turbine engine shaft 410 further includes a turbine rotor 14 as an example of the second component 14. As shown in the embodiment of FIG. 4, the compressor rotor 12 and the turbine rotor 14 are adapted to contact in shear engagement through the curvic coupling configuration 26. However, it is to be appreciated that the compressor rotor 12 and the turbine rotor 14 may be in contact through various configurations that enable shear engagement to transfer torque between the compressor rotor 12 and the turbine rotor 14. Although not shown in FIG. 4, it is to be appreciated that the compressor rotor 12 and the turbine rotor 14 include the first metal substrate and the second metal substrate, respectively, and that protective coating may be disposed on at least one of the first metal substrate or the second metal substrate in accordance with the embodiments described above in the context of FIGS. 1-3.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A coupling apparatus comprising:
a first component comprising a first metal substrate, wherein the first metal substrate comprises a titanium-based material;
a second component comprising a second metal substrate, wherein the second component is adapted to contact the first component in shear engagement; and
a protective coating disposed on at least one of the first metal substrate or the second metal substrate, wherein the protective coating consists of:
a first contact layer having a thickness of less than or equal to about 5 microns and comprising material that is inert to titanium, wherein the first contact layer has a contact surface that is adapted to directly contact an opposing surface in shear engagement; and
optionally, a diffusion barrier layer disposed between the first contact layer and the corresponding metal substrate.

2. The coupling apparatus of claim 1, wherein the protective coating is disposed directly on at least one of the first metal substrate or the second metal substrate.

3. The coupling apparatus of claim 1, wherein the first contact layer comprises material chosen from gold, platinum, cobalt, or alloys thereof; cobalt oxide, boron oxide, or boron nitride; or mixtures thereof.

4. The coupling apparatus of claim 1, wherein the second metal substrate comprises metal chosen from nickel, iron, titanium, alloys thereof, or mixtures thereof.

5. The coupling apparatus of claim 4, wherein the second metal substrate comprises titanium and has substantially the same chemical composition as the first metal substrate.

6. The coupling apparatus of claim 1, wherein the first contact layer is further defined as a physical vapor-deposited contact layer.

7. The coupling apparatus of claim 6, wherein the first contact layer is further defined as an ion-plated contact layer.

8. The coupling apparatus of claim 6, wherein the first contact layer is further defined as a sputtered contact layer.

9. The coupling apparatus of claim 1, wherein the diffusion barrier layer has a thickness of less than about 1 micron.

10. The coupling apparatus of claim 1, wherein the protective coating is disposed on the first metal substrate.

11. The coupling apparatus of claim 10, wherein the diffusion barrier layer comprises tungsten.

12. The coupling apparatus of claim 1, wherein the first component and the second component are adapted to contact in shear engagement through a curvic coupling configuration, with the contact surface of the first contact layer in shear engagement with the opposing surface in the curvic coupling configuration.

13. The coupling apparatus of claim 1, wherein:
the protective coating is disposed directly on at least one of the first metal substrate or the second metal substrate;
wherein the first contact layer is further defined as a physical vapor-deposited contact layer and comprises material chosen from gold, platinum, cobalt, or alloys thereof; cobalt oxide, boron oxide, or boron nitride; or mixtures thereof;
wherein the second metal substrate comprises metal chosen from nickel, iron, titanium, alloys thereof, or mixtures thereof; and
wherein the first component and the second component are adapted to contact in shear engagement through a curvic coupling configuration, with the contact surface of the first contact layer in shear engagement with the opposing surface in the curvic coupling configuration.

14. A method of forming a coupling apparatus including a first component and a second component adapted to contact the first component in shear engagement, the method comprising:
providing a first metal substrate of the first component, wherein the first metal substrate comprises a titanium-based material;
providing a second metal substrate of the second component;
forming a protective coating on at least one of the first metal substrate or the second metal substrate, wherein the protective coating consists of:
a first contact layer having a thickness of less than or equal to about 5 microns and comprising material that is inert to titanium, wherein the first contact layer has a contact surface that is adapted to directly contact an opposing surface in shear engagement; and
optionally, a diffusion barrier layer disposed between the first contact layer and the corresponding metal substrate.

15. The method of claim 14, wherein forming the protective coating comprises forming the first contact layer through physical vapor deposition.

16. The method of claim 15, wherein forming the first contact layer through physical vapor deposition is further defined as forming the first contact layer through ion plating.

17. The method of claim 14, wherein forming the protective coating comprises forming the protective coating directly on at least one of the first metal substrate or the second metal substrate.

18. The method of claim 14, further comprising forming a curvic coupling configuration in the first metal substrate and the second metal substrate, wherein the contact surface of the first contact layer is adapted to directly contact the opposing surface in shear engagement in the curvic coupling configuration.

19. The method of claim 14, wherein:
providing the second metal substrate comprises providing the second metal substrate comprising metal chosen from nickel, iron, titanium, alloys thereof, or mixtures thereof;
forming the protective coating comprises forming the protective coating directly on at least one of the first metal substrate or the second metal substrate; and
forming the protective coating comprises forming the first contact layer comprising material chosen from gold, platinum, cobalt, or alloys thereof; cobalt oxide, boron oxide, or boron nitride; or mixtures thereof through physical vapor-deposited contact layer.

20. A turbine engine shaft comprising:
a compressor rotor comprising a first metal substrate, wherein the first metal substrate comprises a titanium-based material;
a turbine rotor comprising a second metal substrate, wherein the turbine rotor is adapted to contact the compressor rotor in shear engagement and wherein the second metal substrate comprises metal chosen from nickel, iron, titanium, alloys thereof, or mixtures thereof;
a protective coating disposed directly on at least one of the first metal substrate or the second metal substrate, wherein the protective coating consists of:
a physical vapor-deposited contact layer having a thickness of less than or equal to about 5 microns and comprising material that is inert to titanium, wherein the physical vapor-deposited contact layer has a contact surface that is adapted to directly contact an opposing surface in shear engagement and wherein the physical vapor-deposited contact layer comprises material chosen from gold, platinum, cobalt, or alloys thereof; cobalt oxide, boron oxide, or boron nitride; or mixtures thereof; and
optionally, a diffusion barrier layer disposed between the physical vapor-deposited contact layer and the corresponding metal substrate;
wherein the compressor rotor and the turbine rotor are adapted to contact in shear engagement through a curvic coupling configuration, with the contact surface of the physical vapor-deposited contact layer in shear engagement with the opposing surface in the curvic coupling configuration.
